(19) United States
(12) Patent Application Publication
(10) Pub. No.: US 2012/0317492 A1
(43) Pub. Date: Dec. 13, 2012

(54) Providing Interactive and Personalized Multimedia Content from Remote Servers

(75) Inventor: Anthony R. Sheeder, Kensington, CA (US)

(73) Assignee: Telefon Projekt LLC, Kensington, CA (US)

(21) Appl. No.: 13/482,775

(22) Filed: May 29, 2012

Related U.S. Application Data
(60) Provisional application No. 61/491,117, filed on May 27, 2011.

(51) Int. Cl. G06F 3/01; G06F 15/16

(52) U.S. Cl. 715/738

(57) ABSTRACT

An interactive media platform enables users to access a range of media experiences on demand. Each experience is interactive and tailored to the user while the presentation is under way. A client device has a dialog manager that receives input from the user, evaluates the input according to a configuration file, selects media resources according to set criteria from the configuration script, and obtains the selected resources from a remote media server. The system presents the resources in a sequence determined at least in part from user interaction with the presentation.

### PREVIOUS APPLICATION

This application claims priority to provisional patent application 61/491,117, filed May 27, 2011. That application is hereby incorporated herein by reference in its entirety for all purposes.

### FIELD OF THE INVENTION

The invention relates generally to the field of multimedia presentation and in particular to providing interactive and personalized multimedia content from remote servers.

### BACKGROUND

Previous patents and published applications outline technological background that precedes the making of this invention.

U.S. Pat. No. 7,013,275 provides a method and apparatus for dynamic speech-driven control and remote service access systems. Speech is retrieved locally via a client device, speech recognition is performed, and a recognizable text signal is forwarded to a remote server. U.S. Pat. No. 7,137,126 relates to conversational computing using a virtual machine. A multi-modal conversational user interface (CUI) manager operatively connects to a plurality of input-output renderers, which can receive input queries and input events across different user interface modalities.

U.S. Pat. No. 7,418,382 proposes a system for efficient voice navigation through generic hierarchical objects. A server computing device has a means for generating a hierarchical structured document that comprises mapping of content pages. A client computing device has a means for enabling user access to the content pages or dialog services. U.S. Pat. No. 7,519,536 depicts a system and method for network coordinated conversational services. The system comprises various network devices, a set of conversational resources, a dialog manager for managing conversation and executing calls for conversational services, and a communications stack comprising conversational protocols and speech transmission protocols.

Published U.S. application US 2001/0017632 A1 proposes a method for computer operation by an adaptive user interface. Information is collected and stored about the user, a task model is built, the user is offered assistance, and user characteristics are updated. The system interacts with the user through a dialog manager according to an updated user model and user characteristics.

Published U.S. application US 2005/0027539 A1 outlines a media center controller system. The system comprises a computer device having an interface, and a media center command processor comprising an interface to a hand-held device and a dialog manager. The media center command processor is configured to receive audio input from a hand-held device and to perform speech recognition, electronic mail messaging, or device control.

### SUMMARY OF THE INVENTION

Certain embodiments of the present invention provide a technology platform that enables users to call up and enjoy a range of media experiences on demand. Each experience is interactive and tailored to the user while the presentation is under way. A client device on the system has a dialog manager that receives input from the user, evaluates the input according to a configuration script, selects media resources according to set criteria, and obtains the selected resources from a remote media server. The system then presents the resources in a sequence that optimizes the user's experience.

Some aspects of the invention relate to a distributed system for providing interactive media displays. The system includes client devices each configured to display media resources to individual users; a source of media resources that is remote from each device; a media server configured to supply media resources from the source to each device in the system independently and in accordance with each request from the device; and a configuration file available on each device. A dialog manager installed on each device is programmed to independently and reiteratively receive input from the user; perform an evaluation of the input using criteria in the configuration file; select one or more media resources to display according to the evaluation; request the selected media resources from the media server; and cause media resources to be displayed in sequence by the device to the user.

The dialog manager can be programmed so that the configuration file is replaced with another configuration file when prompted by the user. Thus, the system may further include a configuration server for providing a new configuration file selected by a dialog manager in the system according to user input. There is also typically a user input processor electronically or wirelessly connected to the dialog manager. This may include a speech recognition engine, configured to receive vocal input and provide interpretation data determined therefrom. Alternatively or in addition, the user input processor may include a text parser, configured to receive text input and provide interpretation data determined therefrom.

The source of media resources can be a database with audio and/or video resources to be selected by each dialog manager according to a media resource identification tag or “ID” associated with each resource. The source of media resources may also include one or more social media platforms. A user database can also be provided for exchanging user data with each dialog manager. The media server and user database typically supply resources and data to each dialog manager by way of the Internet.

Other aspects of the invention relate to a dialog manager that can be installed on a client device so as to provide an interactive media interface to a user. The dialog manager is configured and programmed to request and receive a configuration file from a remote configuration server; and then to reiteratively perform steps to convey media content to the user. These steps may include: receiving input from the user; sending user input to a user input processor; receiving therefrom interpretation data determined from the user input; selecting one or more media resource IDs by applying a protocol from the configuration file to the interpretation data; fetching from a remote media server one or more media resources according to the IDs selected; and causing the fetched media resources to be presented by the device to the user.

Generally, the configuration file is chosen according to input from the user. The configuration file provides protocols for selecting media resource IDs from the interpretation data, and protocols for selecting and prioritizing media resource ID's independently of interpretation data. The configuration file may specify that user input is to be received only at select times. The dialog manager may update user data on a remote user database after input is received from the user. The user data obtained from the user database may in turn affect selection of resources from the media server.

Other aspects of the invention relate to a client device configured to provide an interactive media interface to a user. The client device may be a hand-held device such as a smart phone, cellular phone or tablet, or it may be a personal computer wired or connected wirelessly to a network such as the Internet.

Other aspects of the invention relate to methods for providing an interactive media experience to a user of a hand-held device or personal computer. The device can request and receive a configuration file from an external configuration server, then reiteratively perform several steps. Such steps can include one or more of the following: receiving input from the user; sending the user input to an interpretation means; receiving therefrom interpretation data determined from the user input; selecting one or more media resource IDs by applying a protocol from the configuration file to the interpretation data; fetching from a remote media server one or more media resources according to the selected IDs; and displaying the media resources to the user in sequence on the device.

Additional aspects of the invention will be apparent from the description that follows.

### DRAWINGS

FIG. 1 is a flow chart that outlines the general procedure followed by an interactive media system according to an embodiment of the present invention, from the point of view of the individual user.

FIG. 2 exemplifies the activity of a Dialog Manager in providing an interactive media experience to a user in accordance with an embodiment of the present invention.

FIG. 3 is a schematic diagram showing a system according to an embodiment of the present invention.

FIG. 4 depicts initiation events in a particular embodiment of the invention.

FIG. 5 illustrates an application architecture for an embodiment of the invention adapted for speech recognition.

FIG. 6 depicts how the Configuration File specifies the order, timing, and interpretation of events and operations executed by the Dialog Manager according to an embodiment of the present invention.

FIG. 7 provides a time line showing interactions among the components of a system to provide a user with an interactive media experience according to an embodiment of the present invention.

FIGS. 8(A), 8(B) and 8(C) list design parameters for a particular implementation of an embodiment of the invention configured for speech input from the user.

FIG. 9 provides an illustration of an embodiment of the invention configured for interaction with text-based and social media platforms.

FIGS. 10(A), 10(B), 10(C) and 10(D) list design parameters for an embodiment of the invention configured for text-based interactions.

### DETAILED DESCRIPTION

Previous technology for providing media via personal or hand-held devices tend to treat users as a passive and homogeneous audience. Systems and methods described here can provide a unique media experience, including audio and/or video elements, to each user that is tailored to their interests and that responds to the user's input.

The sections that follow describe a technology platform that enables individual users to call up and enjoy a range of possible media experiences upon demand. Each experience is interactive to the extent that the user provides input during the media presentation, and the presentation adapts according to the user input and other contemporaneous features or events. The experience is transmitted to the user by way of a personal computer or hand-held device.

The user experience can be implemented in existing consumer devices, including personal computers, computer terminals, cell phones, smart phones, tablets, and other personal or hand-held devices that may be connected to a central data source. Although modeled for implementation on the Internet, the system may be adapted to any public or private data network of common or secure access.

### Technology Platform

In some embodiments, a user's device is adapted to provide interactive media capability by installing a particular software application referred to herein as a “Dialog Manager”. The Dialog Manager provides a platform through which to provide the user with an experience, scripted according to a data file that is specific for the experience chosen by the user, referred to herein as a configuration or “config” file. By following the script in the configuration file, in combination with input from the user and/or from external sources, the Dialog Manager obtains media resources and data files from remote servers over the network and compiles the resources and data in accordance with the configuration file into the experience for presentation on the device for the user.

The Dialog Manager can be loaded onto the device in a manner that is typical for the device being used. For example, for a personal computer, the Dialog Manager can be loaded by way of installing software from a local medium or as an Internet download; for a hand-held device, phone, or tablet by way of an application server or “apps” store. The Dialog Manager typically stays resident on the device and is invocable at will, subject to deletion by the user, and subject to periodic automated or user-prompted updating.

FIG. 1 provides the general procedure followed by the system, from the point of view of the user device. The initiating event (102) is selection by or for the user of a particular experience, for example, by selection in an application on a tablet, or by clicking on a link in a browser. This launches the client (104) (if not already running), and causes the client to obtain the configuration file for the experience, typically from a remote server (106, 108, 110). The Dialog Manager then follows the script of the configuration file, fetching data and media elements from one or more local or remote servers (112) for presentation to the user (114).

Throughout the presentation or at specified times, the client can receive input from the user (116) in a manner in accordance with the device being used, for example, speech (if the device has a microphone or other audio receiver) or text (if the device has a keyboard). Where the input is speech, the Dialog Manager utilizes a speech recognition engine to interpret the input (118, 120). The Dialog Manager then uses the interpretation to select a next media resource based on the interpretation (122) and presents the next resource to the user (124, 126). In some embodiments, the input is interpreted based on a finite set of allowed responses; in other embodiments, the possible options or outcomes are open-ended.

The process reiterates with further user input to continue, expand, and embellish the experience in accordance with the user's demands or interests.

### Dialog Manager

Without implying any functional requirement or limitation on the invention, the Dialog Manager may be thought of as the heart of the system. It is responsible for retrieving, interpreting, and executing the configuration script, and is also responsible for playing any media associated with a given state (typically streamed audio and video) as well as handling, and any user interface events, and implementing the consequences thereof in accordance with the configuration script.

FIG. 2 exemplifies the activity of a Dialog Manager in providing an interactive experience to a user in accordance with an embodiment of this invention.

Upon selection or initiation of an experience by a user (202) (or by a remote server upon user prompt), the Dialog Manager receives a configuration file (204) from a server (206) that corresponds to the selected experience. Typically, configuration files are provided by one or more remote servers that maintain a database of configuration files, which are augmented from time to time with new files and updated files to reflect feedback from users and/or sponsors about files already in circulation. As depicted here, the configuration file is parsed locally by the Dialog Manager to obtain the first data packet (208). Each data packet may provide identifiers for the next one or more media resources to be fetched, its priority in the display queue, and the time window(s) whereby the device and/or the Dialog Manager may be open or receptive to user input. The Dialog Manager then obtains the one or more media resources from a media server (212) and places the resources in the local resource queue (214) in accordance with the priority indicated in the data packet.

The resource queue establishes a hierarchy by which fetched media resources are to be presented, the resource at the front of the queue being presented first (216, 218). At times indicated by the configuration file (220), the input channel is opened for user input (222) while the presentation continues. Absent user input (224, 226), the presentation steps through the hierarchy of resources in the queue (226), until the last media resource is presented, whereupon the presentation terminates (230) (optionally upon presentation of a concluding media resource and/or further prompting of the user for input).

When input from the user is detected (224), the input is interpreted (232, 234) so that the input may be rendered into a form that can be interpreted in accordance with the configuration file. In the case of speech input, a speech recognition engine can be used. Speech recognition technology is described inter alia in U.S. Pat. Nos. 6,993,486, 7,016,845, 7,120,585, 7,979,278, 8,108,215, 8,135,578, 8,140,336, 8,150,699, 8,160,876, and 8,175,883; however, a particular implementation of speech recognition is not critical to understanding the present invention. Where the input is in text format, it is sent to a text parser to extract data suitable for interpretation. Interpretation of speech and/or text input can be performed within the client device or at a remote server as desired.

Once the input data has been interpreted as appropriate, it is then evaluated or scored (236) according to criteria specified in the configuration file. These criteria may be retrieved from the configuration file as part of the previous data packet, or separately once the input is received. Based on the evaluation or score (238), the dialog manager then either terminates the display (230), or retrieves a next data packet from the configuration file (240, 242), comprising an identifier for the next one or more media resources to be retrieved. The media resources are then placed in the queue, and the process reiterates as long as there is input from the user and/or media in the queue that accords with ongoing display as dictated by script in the configuration file.

To provide a wide range of options, the media resources are typically fetched from a remote server. Optionally or as an alternative, media that is sourced frequently may be provided by a media server that is resident on the device with the Dialog Manager.

The Dialog Manager may also source or update other categories of data from remote sources. One example is a remote or local user database (250), or both, which can compile information about the user to further personalize the experience. The data may include data regarding previously interactions of the same user or another user of the same device with the Dialog Manager or the system, such as response choices and response times within certain categories. The data may also include demographic data, such as age, sex, income, spending proclivities, education level, tastes, and other characteristics of commercial interest. Thus, the user database can be sourced as part of the input scoring and choice of media resources made in consultation with the configuration file and/or updated with responses detected during the course of the current presentation.

Other databases that may play into the user experience include commercial or sponsorship databases, which may provide media resources to be integrated with media from the media server and/or data to influence the choice algorithm dictated by the configuration file, in accordance with marketing objectives of the provider or a sponsor of the experience. The system may also source databases that pertain to contemporary data, such as news, sports, or financial markets, so the user may be kept apprised of current happenings and be satisfied as to the timeliness of the information displayed.

### Configuration File

Each experience is scripted according to a configuration file. The file may comprise various features to adjust or adapt the experience in accordance to user input. Such features may include:
Initial media resource(s) to be presented;
Time(s) after commencement of each resource when the system is opened for user input;
Criteria for interpreting and scoring user input;
Choices of resources to be fetched for subsequent display based on input score;
Hierarchy of each media resource in the display queue;
Total duration of presentation (and parameters for adjustment); and
Conclusion protocol and final media resource(s) to be presented.

As part of its function, the configuration file provides a decision tree of actions to take. Typically, at least some of the actions have associated time points at which to take the action, and at least some of the actions are conditioned on user input.

Configuration files may be independently stored and retrieved for each independent experience. Optionally, they may be adapted or updated by the system in accordance with provider objectives and experience.

Interaction with Social Media

In addition or as an alternative to retrieving audio-visual media from a media server, the system may provide an experience that comprises components that are themselves interactive, such as social media platforms and text messaging platforms. Thus, for example, user input may be interpreted by the Dialog Manager in accordance with a configuration file to open a portal to a social media platform that involves displaying user information (such as a blog or brief message), and/or elicits data from third-party customers of the social media (such as responses to user questions and/or a general portal for third-party input).

The Dialog Manager plays the role of determining if, when and how to interface with the social media platform, receiving information from the user for presentation on the social media platform, and/or receiving information from the social media platform for presentation to the user. Any or all of these determinations are performed in accordance with criteria indicated in the configuration that is being executed at the time of the interaction.

### Implementation Overview

Some implementations provide two integrated components: a client-based speech application which renders interactive, multimedia spoken conversations on mobile devices (such as smart phones and tablets), and a server-based text application which renders text-based dialogs on existing or novel messaging platforms. The applications, which share a database capable of storing user and session data, deliver interactive extensions of the social media presence of personae—characters, celebrities, brands, and ultimately consumers themselves.

FIG. 3 is a schematic diagram showing a screen according to an embodiment of the invention. The system comprises a Server (A) that provides various functions to the system as a whole. Included are a Configuration Server (A1), a Media Server (A2), a Speech Recognition Engine (A3), a User Database (A4), a Dialog Manager for text interactions (A5), and a Text Parser (A6). The system also comprises a Client application (B) that includes a Dialog Manager for speech interactions (B1), and optionally a local Speech Recognition Engine (B2), a repository of local Media Resources (B3), and a local database for storing User Data (B4). The Client application (B) is designed to be installed on mobile devices (C), such as smart phones and tablet devices, equipped with the necessary interface components. The Client (B) is capable of interacting with interacting with third-party social media platforms (E) (such as Facebook™, Twitter™) in order to gather public information and perform basic functions particular to the social media platforms. The text Dialog Manager (A5) is designed to interact with third-party social media platforms (E) and existing third-party Text Messaging platforms (D) including IM and SMS.

In this depiction, a Dialog Manager is shown on the client for speech management, and a separate Dialog Manager is shown at a remote location for text management. As an alternative, the two Dialog Managers can be consolidated on the client or remotely. Media resources may be obtained from one or more local or remote media servers, or both in combination. Speech recognition engines and text parsers may be locally implemented on the device, or provided remotely, depending on the sophistication of the device and the design choices of the programmer. The device may also include a general local storage unit to buffer media and data obtained from the various remote servers being sourced.

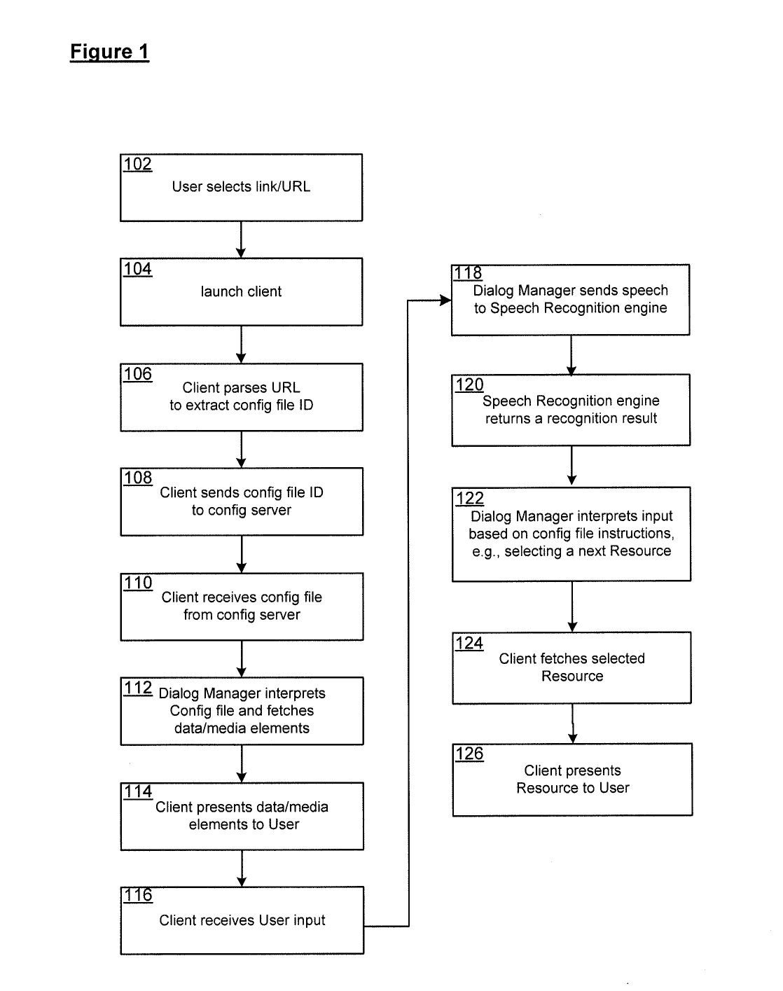

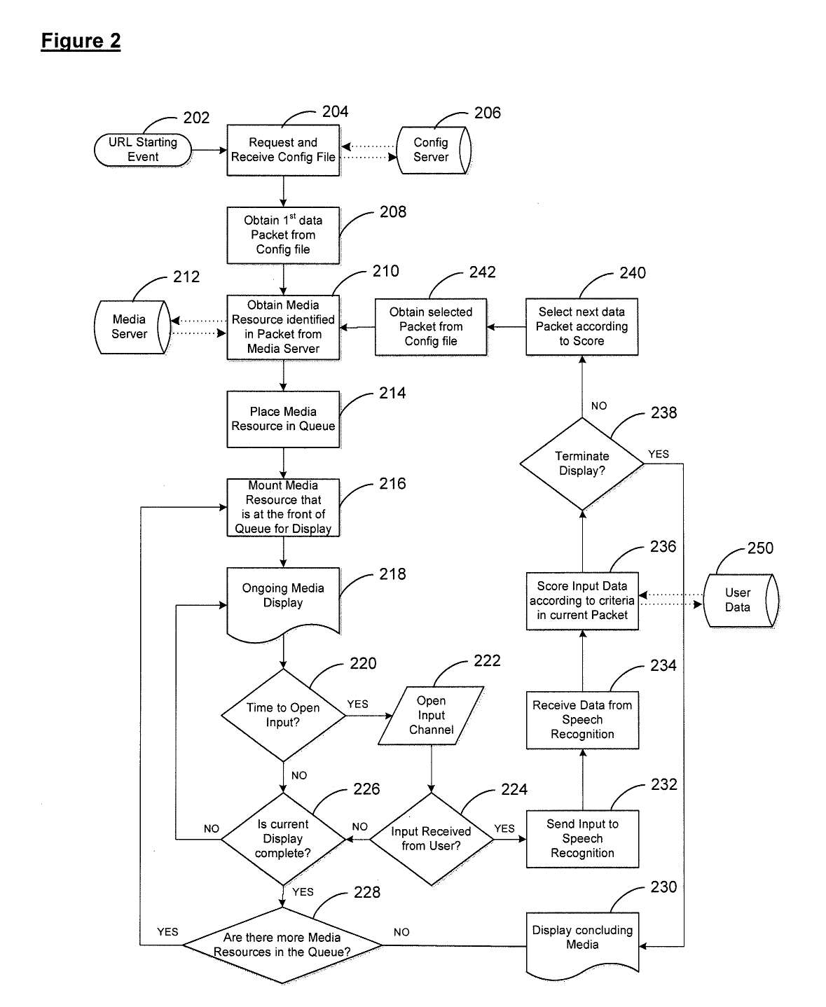

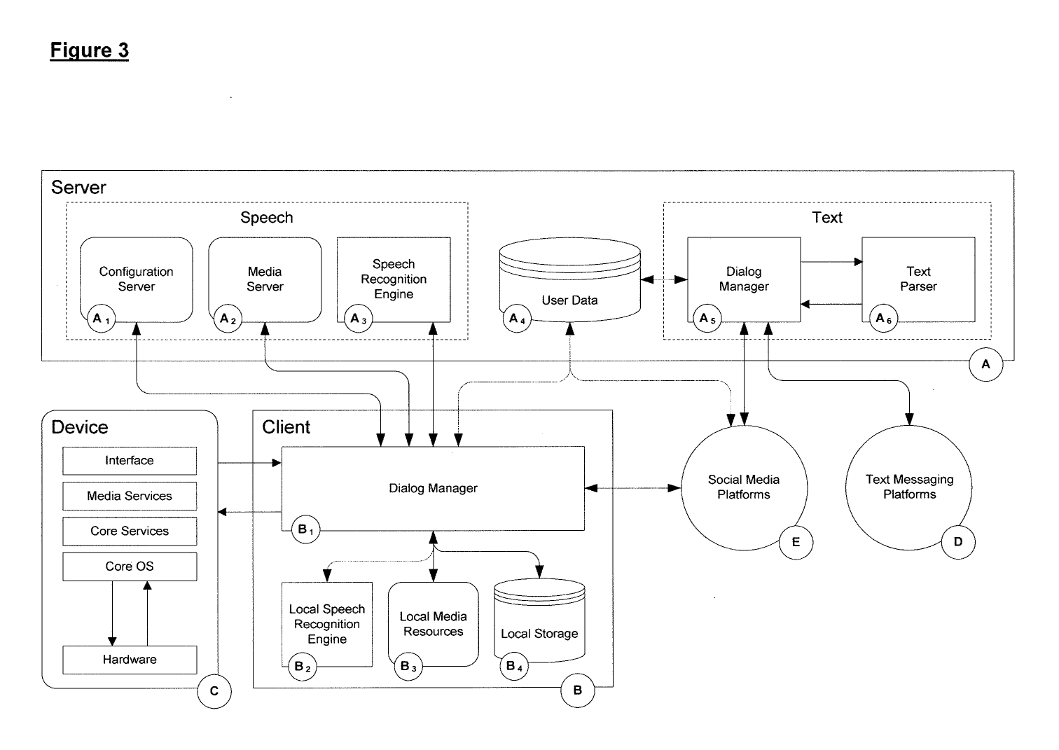

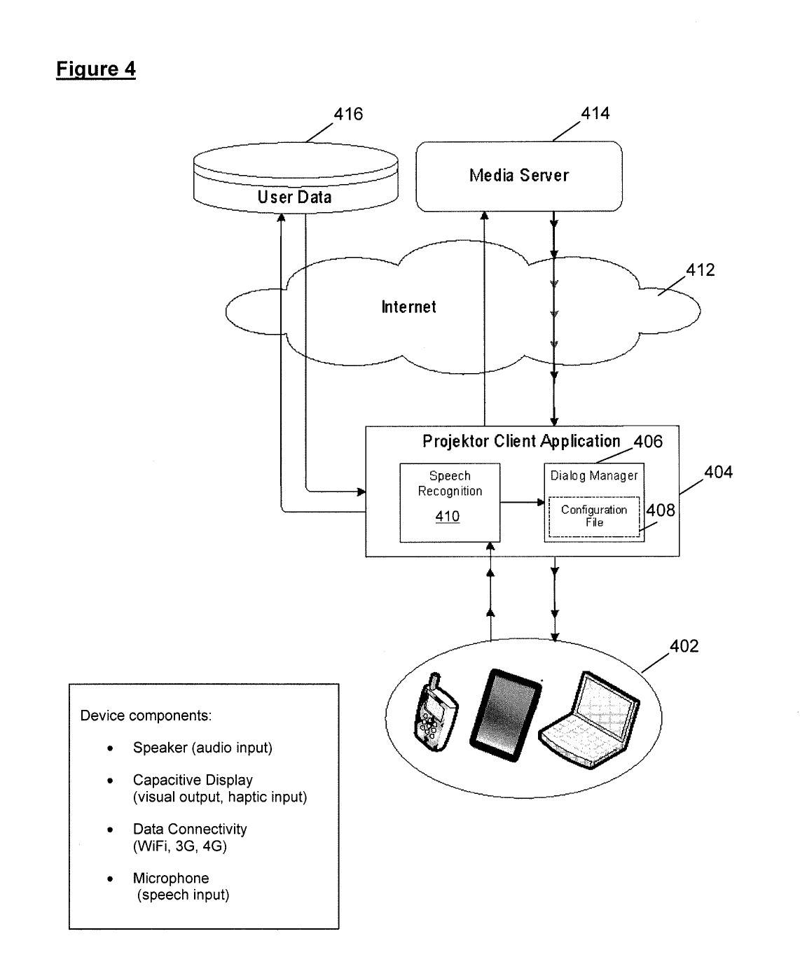

FIG. 4 shows another view of a system configuration according to an embodiment of the present invention. User devices 402 (e.g., smart phones, tablets, laptops, etc.) each have client application 404 installed thereon. Client application 404 includes Dialog Manager 406, which is capable of parsing configuration files to determine actions to be taken, including receiving and preserving media content interactively based on user input. The user input can include speech, and accordingly client application 404 can include speech recognition engine 410. Client application 404 can also communicate via a network 412 (e.g., the Internet) with media server 414 to retrieve media content for presentation and with a user data store 416 to retrieve user-specific information that can be used to further tailor the presentation to an individual user.

In this embodiment, the Client application may be installed and run on mobile computing and communications devices 402 (such as smart phones, tablet computers) that are equipped with the following components: a microphone to accept speech input; a speaker to present audio output; a capacitive display to present visual output and to accept haptic input; and wireless data connectivity (WiFi, 3G, 4G) to allow communication with remote components such as media server 414 and user data store 416.

### Platform for Speech Interaction

In an exemplary embodiment of the invention, a speech-based platform integrates local and networked Speech Recognition Engines, a Dialog Manager, Configuration and Media Servers, and one or more back-end Databases. This is integrated by the system to render multimedia experiences. The platform comprises server-side functionality and a mobile client application that runs on devices such as smart phones and tablets.

The client application in some embodiments is a light-weight player that can interpret and execute various user interactions by way of a Configuration Script (written in a suitable computer-readable code, such as XML). When the application is launched, it is capable of retrieving, interpreting, and executing the configuration file. The configuration file contains information about each state of the application including information about what media (video, audio, etc.) to present for that state, what input mechanisms to accept, what speech recognition results to accept, and how to transition from one state to another based on user input. At a high level, the client application is capable of:
invoking native audio resources (microphone and speaker);
capturing speech input;
passing captured speech input to a recognition engine;
performing recognition on speech input (in specified contexts);
interpreting or acting on recognition results returned by the engine;
capturing specified haptic input (button presses, text input, etc.);
declaring, assigning, and acting on session variables;
maintaining session context;
presenting streaming media (audio and video); and/or
reading from and writing to a backend database.
   The server-side performs the following:
serving XML configuration files;
serving media (audio and video) files;
performing recognition on speech input (in specified contexts);
monitoring bandwidth and any other media constraints; and/or
maintaining context-sensitive user data.

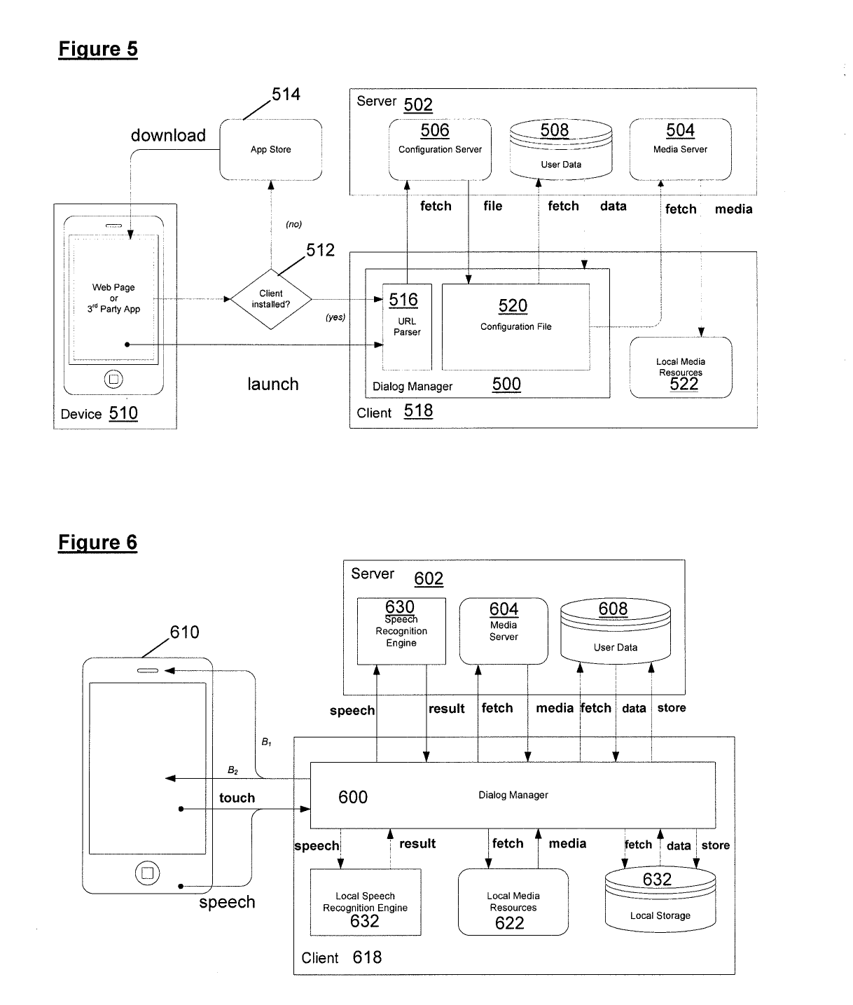

FIG. 5 illustrates the application architecture of this embodiment, adapted for speech recognition. The client-based Dialog Manager 500 is able to pull resources locally and over the network. Server-based resources 502 include a Media Server 504 for streaming audio and video content, a web-based server for XML Configuration Scripts 506, a data store 508 for storing and serving collected user data, and a speech recognition engine (not shown).

A particular application is invoked when user clicks on a link to a Custom URL Scheme in a browser (on a web page) or in a third-party application (such as Twitter, Facebook) using user device 510. If the Client is not installed (512), the link redirects to an Application Store (514) where the application is available for download. Upon installation the Client is launched and the URL is parsed by parser 516 within client 518. If the Client is already installed on the device, the link launches the Client and parses the URL. The Client extracts parameters from the URL, including the unique identifier for the Configuration File containing the logic that will control the experience, and sends a fetch request to the Configuration Server 506. The Configuration Server 506 sends the requested Configuration File 520 back to the Client application. The Dialog Manager 500 interprets the Configuration File 520 and, if specified, sends a fetch request to the User Database 508, in response to which the User Database 508 sends the specified data elements back to the Dialog Manager. Likewise, if specified in the Configuration File 520, the Dialog Manager 500 sends a fetch request to the Media Server 504, which sends the specified media files (such as video, audio, images) back the Local Media Resource repository 522 on the Client 518.

In FIG. 6, the Configuration File specifies the order, timing, and interpretation of events and operations executed by the Dialog Manager 600. The user provides input—either speech or haptic—to device 610, which is interpreted by the Dialog Manager 600 (per the Configuration File). In the case of speech input, in accordance with timing specified in the Configuration File, the Client 618 activates the microphone and streams audio input (speech) from the user to either a networked speech recognition engine 630 or to the onboard recognition engine 632. The Speech Recognition engine (630 or 632) analyzes the audio and returns a recognition result to the Dialog Manager 632. Based on the recognition result, the Configuration File specifies a media file to play in response and the Client Application 618 sends a fetch request to the Media Server 604, which then streams the requested media to the device 610 via the Client 618. In the case of haptic input, the Dialog Manager 600 bypasses the Recognition Engines and acts on that input directly. In some (specified) contexts, the Dialog Manager can fetch media files from the repository of local Media Resources 622. In the course of an interaction, the Configuration File may specify that information be fetched from or written to the networked User Database 608, or that information be fetched from or written to a local database 632.

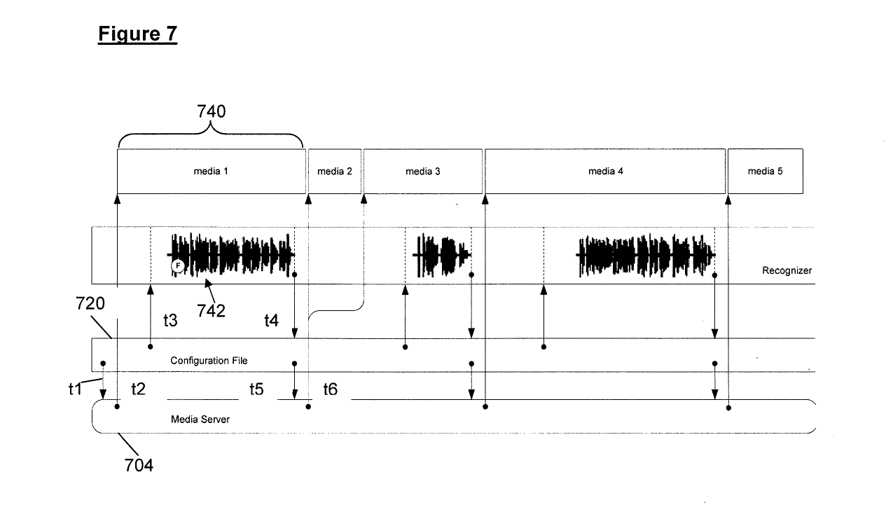

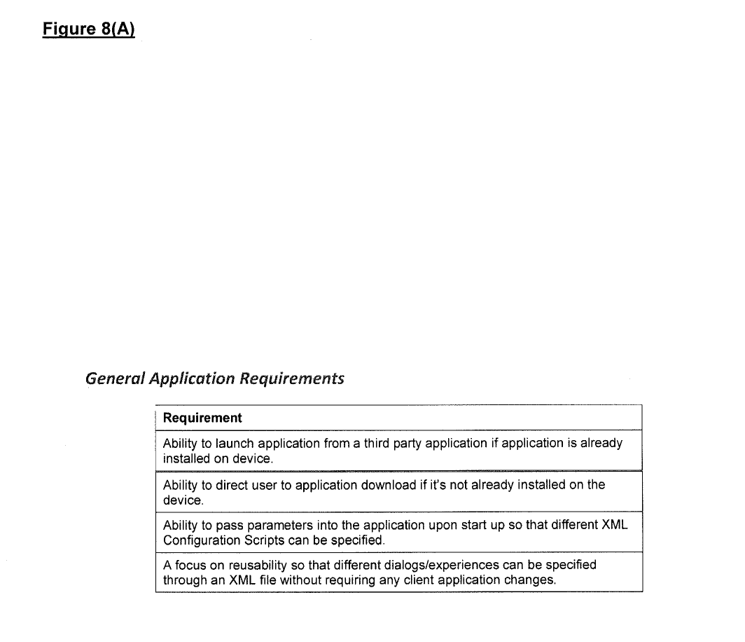

FIG. 7 portrays a time line showing how the components of the system might interact to provide the User with an interactive display. The Dialog Manager, based upon specifications in the Configuration File 720, sends a fetch request for a particular media file (or files) to the Media Server 704 at time t1. In return, the Media Server sends the specified media file to the device at time t2, via the Dialog Manager, for presentation (at 740). At specified junctures, e.g. at time t3 (timed relative to the media being presented), the Dialog Manager invokes a Speech Recognition Engine, and the Recognizer begins ‘listening’ for input. When the user responds—using speech—the recognizer evaluates the utterance (742) and sends the recognition result to the Dialog Manager at time t4. Based on conditions specified in the Configuration File, the Dialog Manager sends a fetch request to the Media Server 704 at time t5 for the media file (or files) associated with the user's response (utterance). In some instances, multiple media files may be fetched from the Media Server at time t6 and queued for presentation by the Dialog Manager. This process can continue through any number of media files.

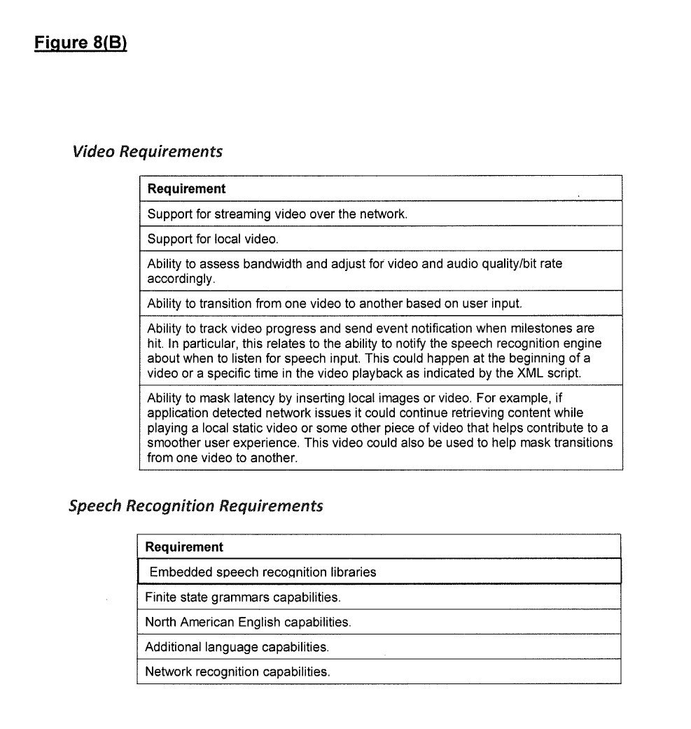

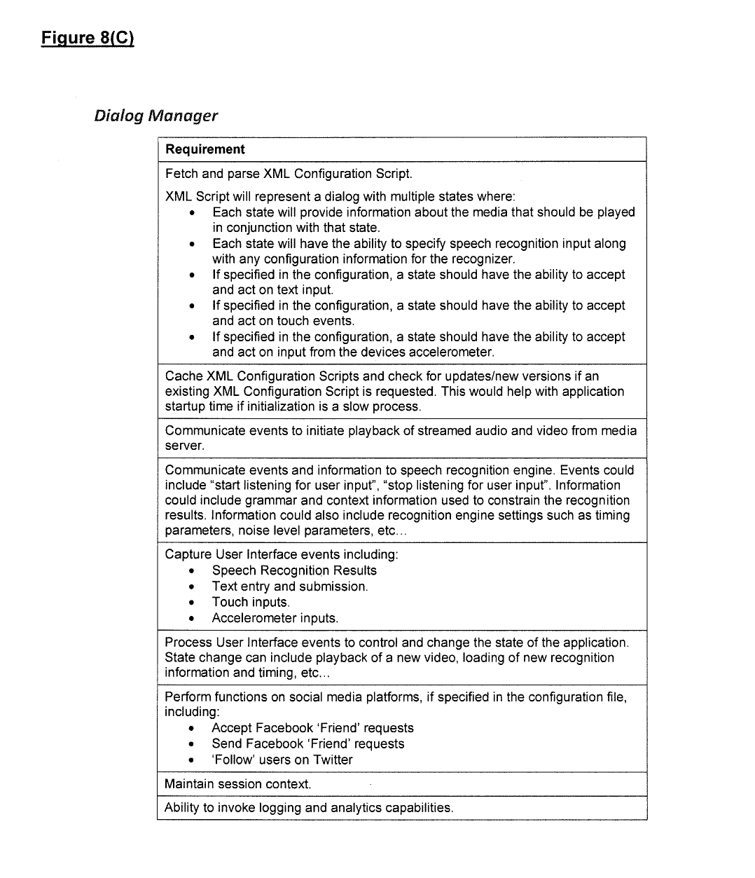

FIGS. 8(A), 8(B) and 8(C) list design parameters for a particular implementation of an embodiment of the invention. These parameters are for illustration purposes only and do not limit the general practice of the invention. A number of tablets, smart phones, and other user devices having different form factors and/or operating systems can be supported.

Video playback may be a vital component of the user experience. The client application advantageously has ability to smoothly play back video, and transition from one video to another, as seamlessly as possible. Video is primarily hosted remotely and streamed to the application on demand, though there can be use cases where the user downloads local video with the application. Speech recognition capabilities can be the primary input mode of the application, with the goal of giving the user the experience of conversing with one or more characters in the video. The application has the ability to capture (log) user information and usage statistics. Logging can be approached from both an application health perspective (such as debugging, tuning the recognition engine) as well as from an analytics perspective (such as usage statistics or user profile information).

### Text-Based Platform

In some embodiments, a text-based platform comprises a Dialog Manager and a text parser, along with a backend database (shared with the speech-based application), in order to render text based dialogs between automated personae and live interlocutors. The application can be bound to existing messaging platforms—SMS, IM clients (e.g., AIM, Yahoo, Skype, etc.), and social media (e.g., Facebook, Twitter)—or to a web or other interface.

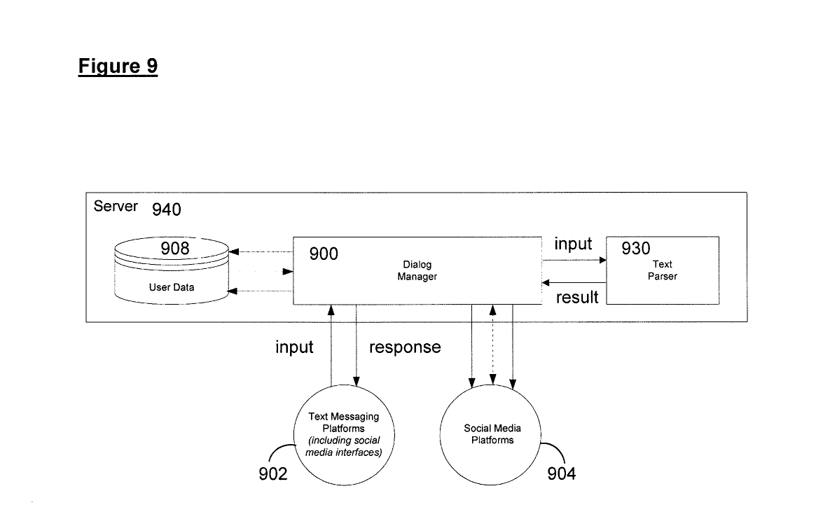

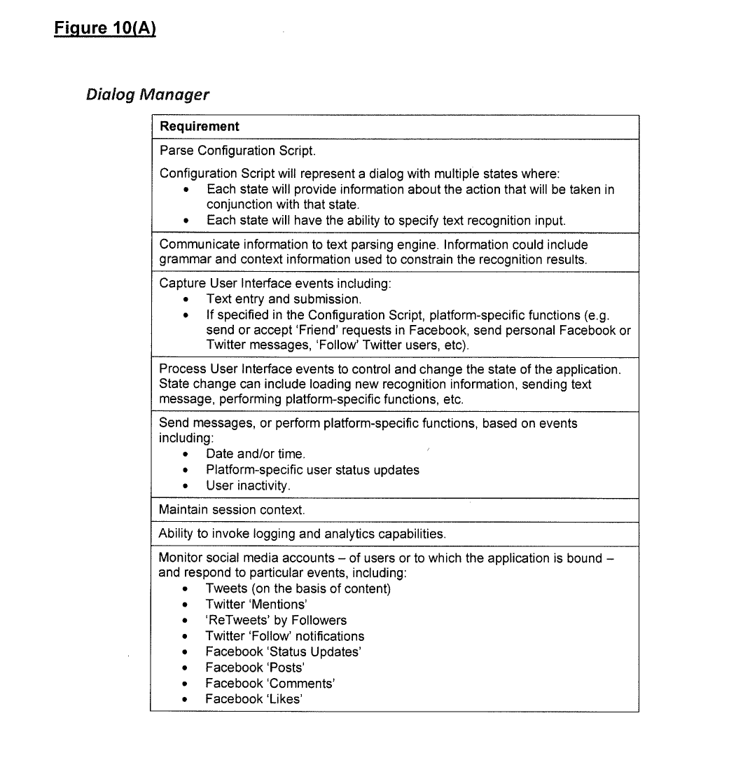

FIG. 9 illustrates an embodiment of the invention configured for text-based interactions with text messaging platforms 902 and social media platforms 904. The user provides input, in the form of text, to the platform 902. Platform 902 routes the input to dialog manager 900. Dialog manager 900 uses text parser 930 to parse the input and provide a result. Based on the result, dialog manager 900 generates a text response to platform 902, which delivers the response to the user. Similarly, a user can provide input to social media platform 904 and receive responses. User data 908 can be used to tailor the responses to a particular user.

In this illustration, the Dialog Manager 900 is a finite state machine capable of sending and receiving messages based on events specified in a configuration file. The Dialog Manager 900 is capable of maintaining the context of messages it receives, sending received messages (text strings) to a parser 930, and acting on the results returned by the parser 930. The parser 930 receives the text strings from the Dialog Manager and interprets them relative to context-specific grammars defined in the configuration file. The parser is capable of matching against individual words, phrases, combinations of words and phrases (e.g., string including both X and Y), and more semantically complex constructions (e.g., string includes either Y or Z and not X). In addition to sending and receiving text messages, the Dialog Manager is capable of performing standard platform-specific social media functions (e.g. sending “Friend” requests to a particular user's Facebook account, accepting “Friend” requests from a Facebook user). The Dialog Manager is also capable of monitoring a particular user's social media accounts and responding to platform-specific events (e.g. status updates or posts to “Friended” users' Facebook accounts, tweets from Twitter “Followers”) in conjunction with specified content variables.

In addition to simple text messages, the Dialog Manager 900 may be capable of performing various operations relative to particular social media platforms. On the one hand, the Dialog Manager 900 is capable of various functions on existing social media platforms—e.g., tweet, retweet, and follow on Twitter; update status, post, comment, and like on Facebook. On the other hand, the Dialog Manager 900 is also capable of monitoring and responding to activity on the social media platforms.

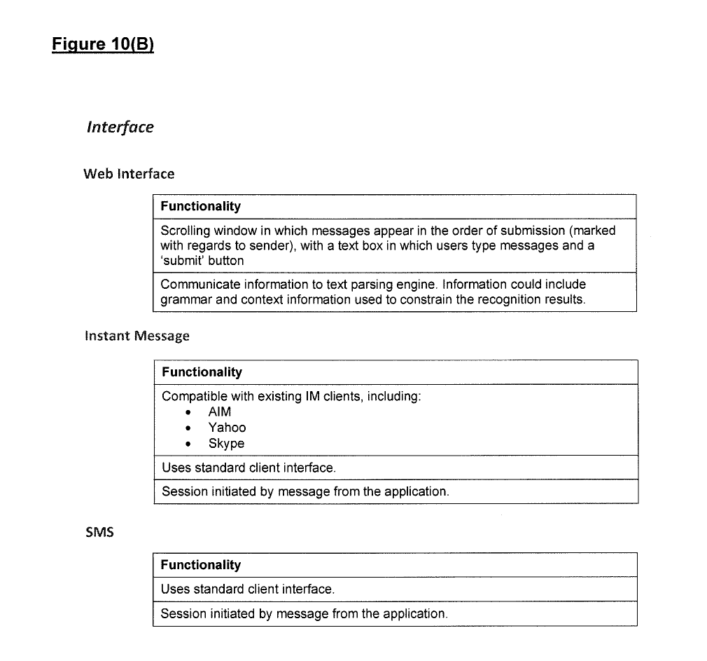

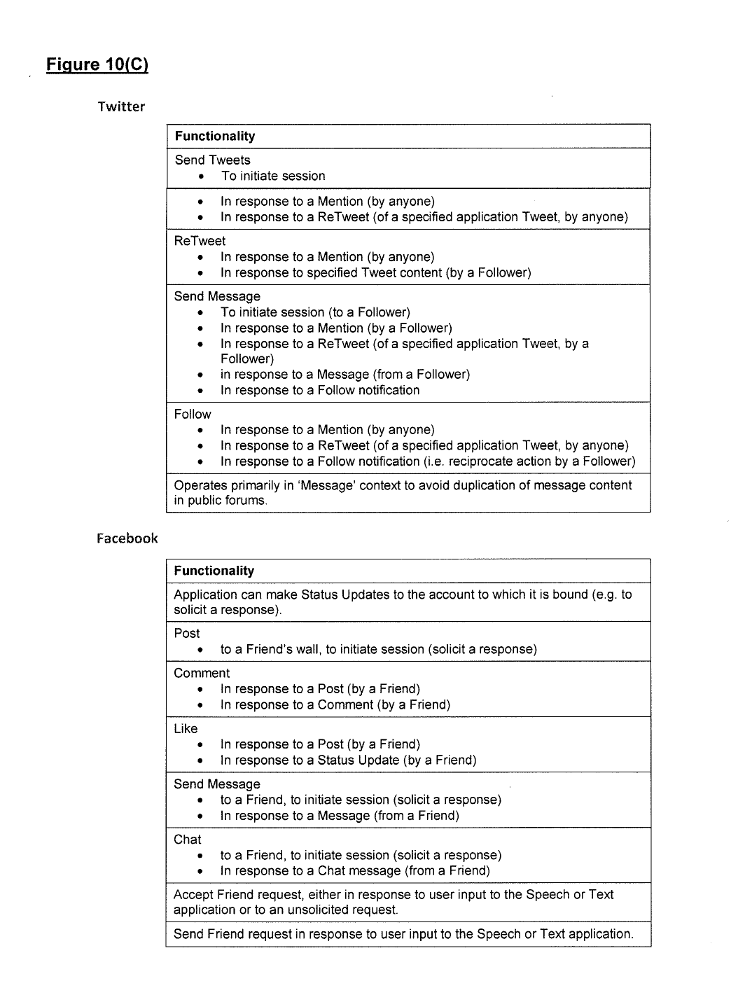

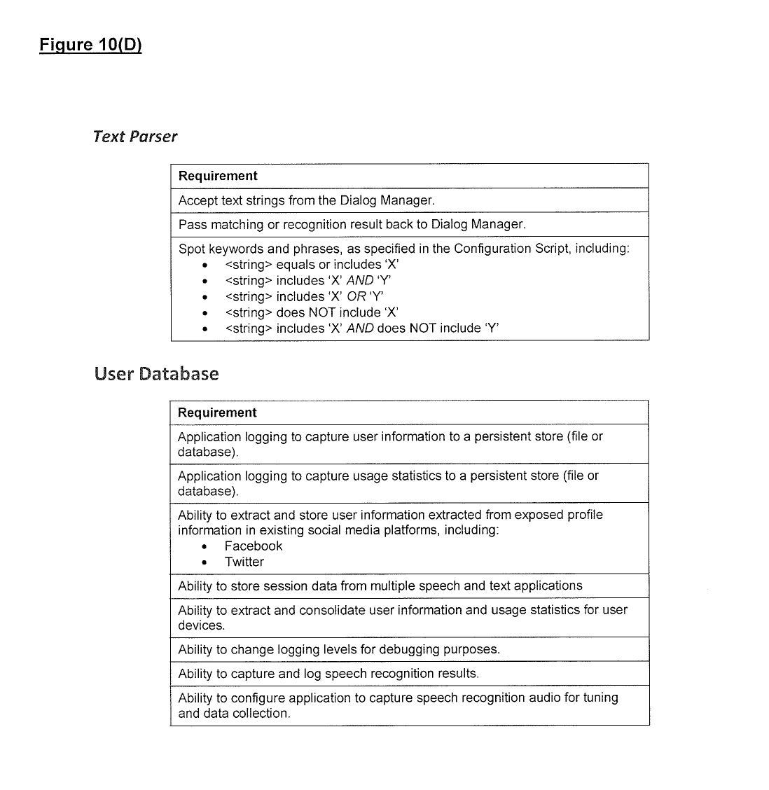

FIGS. 10(A), 10(B), 10(C) and 10(D) list design parameters for an embodiment of the invention configured for text-based interactions. These parameters are for illustration purposes only, and do not limit the general practice of the invention.

The interface for any given text application can be analogous to a live text chat, with the server 940 and a user providing alternating messages. The dialog exchanges can be implemented on a variety of platforms, including a web interface; an instant messaging client (AIM™, Yahoo™, Skype™); SMS™; Twitter™; and Facebook™. The text parser 930 receives the text strings from the Dialog Manager 900 and interprets them relative to context-specific grammars defined in the Configuration Script. The server 940 can access a back-end database, optionally shared by speech applications and text applications, capable of storing structured user and application data, to further customize the experience.

While the invention has been described with reference to specific embodiments, persons of ordinary skill in the art with access to the present disclosure will recognize that numerous modifications are possible and that features described with specific reference to one embodiment can be applied in other embodiments. Accordingly, it will be appreciated that the invention is intended to cover all modifications and equivalents within the scope of the following claims.

What is claimed is:

1. A system for providing interactive media displays, the system comprising:
a) a plurality of client devices, each configured to display media resources to individual users;
b) a source of media resources remote from each client device;
c) a media server configured to supply media resources from the source to each client device in the system independently and in accordance with specific requests from the client devices;
d) a configuration file available on each client device; and
e) a dialog manager on each client device, wherein each dialog manager is configured to independently and reiteratively:
(i) receive input from a user;
(ii) perform an evaluation of the input using criteria in the configuration file;
(iii) select one or more media resources to display according to the evaluation;
(iv) request the selected media resources from the media server; and
(v) cause media resources to be displayed in sequence by the device to the user.

2. The system of claim 1, wherein each dialog manager is programmed so that the configuration file is replaced with another configuration file when prompted by the user.

3. The system of claim 1, further comprising a configuration server for providing a new configuration file to a particular dialog manager in response to a request from the particular dialog manager.

4. The system of claim 1, further comprising a speech recognition engine coupled to the dialog manager and configured to receive vocal input and provide interpretation data determined therefrom.

5. The system of claim 4, wherein the speech recognition engine is remote from each client device.

6. The system of claim 1, further comprising a text parser configured to receive text input and provide interpretation data determined therefrom.

7. The system of claim 1, wherein the source of media resources comprises a database with audio and video resources to be selected by each dialog manager according to a media resource ID associated with each resource.

8. The system of claim 1, wherein the source of media resources comprises one or more social media platforms.

9. The system of claim 1, further comprising a user database for exchanging user data with each dialog manager.

10. The system of claim 1, wherein the media server supplies media resources to each dialog manager via the Internet.

11. A client device comprising:
a user interface including at least a microphone, a haptic input sensor, a display, and an audio output;
a network interface to access remotely stored information; and
a processor coupled to the user interface and the network interface, the processor being configured to execute a dialog manager,
wherein the dialog manager is configured:
(a) to request and receive a configuration file from a remote configuration server; and
(b) to reiteratively perform the following steps:
(i) receive input via the user interface;
(ii) interpret the user input to generate interpretation data;
(iii) select one or more media resource IDs by applying a protocol from the configuration file to the interpretation data;
(iv) fetch from a remote media server one or more media resources according to the selected media source IDs; and
(v) cause the fetched media resources to be presented in sequence at the user interface.

12. The client device of claim 11, wherein the configuration file is requested and received in step (a) in response to input received at the user interface.

13. The client device of claim 11, wherein the configuration file provides protocols for selecting media resource IDs from the interpretation data and protocols for selecting and prioritizing media resource IDs independently of interpretation data.

14. The client device of claim 11, wherein receiving user input at step (i) occurs only at select times according to criteria in the configuration file.

15. The client device of claim 11, wherein the dialog manager is further configured to update user data on a remote user database after input is received from the user at step (i).

16. The client device of claim 15, wherein the dialog manager is further configured to obtain user data from the user database and wherein the obtained user data affects selection of the media resources in step (iv).

17. The client device of claim 11, wherein the device is a hand-held device.

18. The client device of claim 11, wherein the device is a personal computer.

19. The client device of claim 11, wherein the user input includes speech and the dialog manager is further configured such that interpreting the user input at step (ii) includes sending the user input to a speech recognition engine and receiving the interpretation data from the speech recognition engine.

20. A method of providing an interactive display to a user of a hand-held device, the method comprising:
(a) requesting and receiving a configuration file from an external configuration server; and then
(b) reiteratively performing the following steps:
(i) receiving input from the user;
(ii) interpreting the user input to generate interpretation data;
(iii) selecting one or more media resource IDs by applying a protocol from the configuration file to the interpretation data;
(iv) fetching from a remote media server one or more media resources according to the selected media resource IDs; and
(v) presenting the media resources to the user in sequence on the hand-held device.
